(19) United States
(12) Patent Application Publication
(10) Pub. No.: US 2026/0126265 A1
(43) Pub. Date: May 7, 2026

(54) Safe Handle

(71) Applicant: Chance Shockey, Buckeye, AZ (US)

(72) Inventor: Chance Shockey, Buckeye, AZ (US)

(21) Appl. No.: 19/237,207

(22) Filed: Jun. 13, 2025

Related U.S. Application Data
(60) Provisional application No. 63/661,336, filed on Jun. 18, 2024.

(51) Int. Cl. F41B 13/08; E05G 1/02

(52) U.S. Cl. CPC F41B 13/08; E05G 1/02

(57) ABSTRACT

The present invention is a protection device for a safe opening mechanism having a removable armature with a handle grip on one end, a spike on the other end and an adapter about its middle for connecting to a hollow spoke shaft or hollow lever securing connector of a safe opening mechanism. A removable armature may be secured in one or more of the hollow spokes or a lever of the safe opening mechanism. The invention includes the protection device, the protection device incorporated into a hollow spoke or hollow lever of the safe opening mechanism, a handle of a safe opening mechanism containing one or more hollow spokes or hollow lever housing the protection device and a safe with the handle containing the protection device.

### CROSS-REFERENCE TO RELATED APLICATIONS

This application claims priority to U.S. Provisional Application Ser. No. 63/661,336 filed on Jun. 18, 2024, which is incorporated herein in its entirety by this reference.

### STATEMENT REGARDING FEDERALLY SPONSORED RESEARCH OR DEVELOPMENT

Not applicable

### THE NAMES OF THE PARTIES TO A JOINT RESEARCH AGREEMENT

Not applicable

### INCORPORATION-BY-REFERENCE OF MATERIAL SUBMITTED ON A COMPACT DISC

Not applicable

### TECHNICAL FIELD

The present invention relates generally to defense devices associated with security safes. More specifically, concealed weapons on or within a safe.

### BACKGROUND OF THE INVENTION

Safes are used by many to protect a variety of important items. These may include jewelry, gold coins and the like or documents that cannot be copied or are executed originals of important papers. Safes act as one line of defense against those who would steal such items. However, while they are a deterrent, like an alarm system, they cannot protect an individual from being forced under duress to open the safe. In these circumstances, the owner may be threatened with a firearm or other handheld weapon, like a knife. This renders the owner helpless, hoping that once the safe is opened, the perpetrator will simply leave with the contents without harm to the owner, the family or further damage to property.

Some owners often house a handgun in the safe for just such a circumstance. However, a repeat offender will often anticipate this and stand some distance from the individual opening the safe and instruct them to move away from the safe once it has been unlocked but not opened.

Insurance can offer some comfort in the event of theft, but while most items generally stored in a safe are insurable some are not. For example, insurance companies will cover jewelry provided there is evidence of value such as a purchase receipt or an appraisal, however, they will not often cover cut gemstones that have not been set in jewelry. In addition, some documents if stolen cannot be replaced, and in many cases, of no interest to the perpetrator but taken, nonetheless.

Some safes contain a safe within the safe. These are often provided in gun storage safes where the weapons are accessible when the door to the safe is opened, but the ammunition kept in the internal safe is not. Unfortunately, under circumstances where the theft of items is the intent, the owner will likely be forced to open both safes.

A camera may be installed in a hidden location to take images of the perpetrator in the act of stealing the contents of a safe. This can assist in identifying and hopefully bringing the perpetrator to justice. Unfortunately, while this may act as a deterrent for future theft, it does not enable the individual to have the option of potentially preventing the theft.

Consequently, there is a need in the security industry for a device that can allow an individual under duress to defend his/her belongings in the form of a concealed weapon that may provide an element of surprise when resisting the theft.

The forgoing examples are intended to be illustrative and not exclusive, and they do not imply any limitations on the invention described and claimed herein. Various limitations of the related art will become apparent to those skilled in the art upon a reading and understanding of the specification below and the accompanying drawings.

### SUMMARY OF THE INVENTION

The present invention is a protection device for a safe opening mechanism comprising a removable armature having a first end, a middle and a second end and a spike. The first end has a handle grip. The middle has an adapter for connecting to a hollow spoke or lever of a safe opening mechanism. The second end has an attachment connector to receive the spike. The spike has a back end and front end wherein the back end is be affixed to the attachment connector of the armature and the front end is pointed.

In another aspect of the present invention, the protection device is concealed in a hollow spoke or lever of the handle for a safe opening mechanism. The hollow spoke shaft or lever having two ends, one end having a threaded portion for affixing the hollow spoke or lever to a safe opening mechanism and the other end having a securing connector to receive the removable armature.

Another aspect of the present invention is a safe having a secure compartment for storing items, a door, and an opening mechanism in the door to secure the items stored in the secure compartment, wherein the handle of the safe opening mechanism contains one or more hollow spokes or a lever for concealing the protection device.

In one embodiment the handle for a safe comprises a hub with two or more hollow spokes wherein at least one of the hollow spokes contains a protection device.

In another embodiment the securing connector of the hollow spoke shaft or lever is a pin and groove connector, a ball and spring connector or a compression washer connector. When the securing connector is a pin and groove connector it may be an L-shaped channel and the middle of the removable armature having a pin configured to fit within the L-shaped channel, wherein the pin locks within the L-shaped channel through a pressure fit. In a similar configuration the L-shaped channel may form an angle greater than 90 degrees. In another configuration, the pin and groove may be a T-shaped channel, and the removable armature has a pin configured to fit within the T-shaped channel, wherein the pin locks within the T-shaped channel through a pressure fit. Another configuration may be a Y-shaped channel, wherein the pin locks within the Y-shaped channel through a pressure fit.

In yet another embodiment the protection device may comprise a battery connected to a electronic circuit, wherein the electronic circuit controls, and is connected to, a capacitor wherein in the capacitor is charged by the battery and has a positive and a negative electrode exposed on the surface of the removable armature's spike such that, when there is connectivity of the negative and positive electrodes, a charge in the capacitor is discharged. Alternatively, the spike may contain a chemical that causes severe pain or incapacitates an individual when the skin of the individual is penetrated by the removable armature's spike, wherein the chemical is a heavy metal salt and is coated on the surface or is released from the spike upon impact with the individual.

In yet another embodiment the handle further comprises a threaded adapter, wherein the threaded adapter may be affixed to the securing connector of the hollow spoke shaft or lever to allow attachment of the hollow spoke shaft or lever to different types of safe opening mechanisms.

### BRIEF DESCRIPTION OF THE DRAWINGS

FIG. 1: are perspective views of the removable armature and the hollow spoke of one embodiment of the invention.

FIG. 2: are perspective views of the removable armature, the electronic circuit board connected to electrodes, and the hollow spoke of one embodiment of the invention.

FIG. 3: are top, bottom and side views of the removable armature, the electronic circuit board connected to electrodes and the hollow spoke of one embodiment of the invention.

FIG. 4: is a schematic of one example of the electronic circuit board of the present invention.

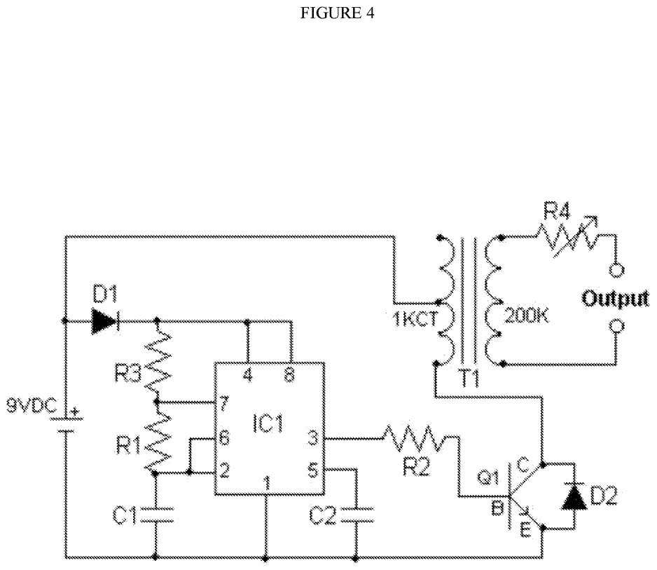

### DETAILED DESCRIPTION OF THE INVENTION

Unless defined otherwise, all terms used herein have the same meaning as are commonly understood by one of skill in the art to which this invention belongs. All patents, patent applications and publications referred to throughout the disclosure herein are incorporated by reference in their entirety and considered relevant in view of the present invention. In the event that there is a plurality of definitions for a term herein, those in this section prevail.

The term “about” as used herein refers to ±10% of any numerical value presented within the disclosure.

The term “safe opening mechanism” as used herein refers to the components of a safe other than the storage compartment. More specifically, the safe opening mechanism is the locking mechanism that is usually located in the door of a safe. The locking mechanism may include one or all of the elements listed. A code input system (e.g., a push button panel, fingerprint recognition panel, retinal scanner, dial or other similar system known to those in the art), a handle (e.g., lever, wheel or other element that is gripped by the hand to open the door of the safe), a hub that connects the handle to gearing elements within the door, gears within the door that connect the handle to, and transfers motion from, the handle to the door securing elements and the bolts of the door securing elements that secure the door.

The term “removable armature” as used herein refers to the portion of the protection device that comprises a handle grip on one end (i.e., the first end) and attachment connector on the other end (i.e., the second end) for receiving a spike, an adapter about the middle of the armature for connecting the armature to a hollow hand lever securing connector or a hollow spoke of a hand wheel used for opening a security safe and a spike.

The phrase “adapter” in reference to connecting the removable armature to a hollow spoke or lever securing connector as used herein means a connector that allows the removable armature to be securely connected, or quickly released from, the hollow spoke or lever using methods known in the art for twist release mechanisms or push-button release mechanisms. However, any connection means that achieves quick and easy removal and replacement of the armature in a hollow hand lever or hollow spoke is envisioned.

The term “attachment connector” as used herein refers to a mechanism for securely affixing a spike to the second end of the removable armature. There are a variety of methods known to those skilled in the art that may be used as an attachment connector. For example, the second end of the removable armature may have a hollow recess in which a spike or other similarly configured weapon may be inserted. The edge of the recess may have one or more threaded apertures to receive one or more securing screws to affix the spike securely in the second end of the removable armature. Alternatively, the second end may be threaded or have a threaded recess for receiving a threaded recess or threaded back end of the spike.

The terms “spike”, “knife” and/or “knife blade” as used herein refers to an elongated shaft with a point on one end. The shaft may be provided in a variety of configurations including, for example, cylindrical, flat, triangular, or square. The length may be tapered from the back end to the front end, or the shaft may merely have a point on one end. If the shaft is relatively flat, it may have a blade formed on one or both sides and a pointed tip. The back end of the spike may have one or more apertures in which the securing screws may be received to secure the spike to the second end of the removable armature. Alternatively, the back end may be threaded or have a threaded recess for receiving a threaded recess or threaded second end of the removable armature.

The phrases/terms “hollow spoke” hollow spoke shaft”, “shaft”, “spoke” or “hollow lever” or “lever” as used herein refer to the casing in which the removable armature is retained when not in use. The hollow spoke or hollow lever has sufficient area within to house the spike element of the removable armature, has an adapter for connecting the removal armature to the hollow spoke or hollow lever on one end and the other end being threaded to allow the hollow spoke or hollow lever to be connected to the hub of a safe opening mechanism.

The term “securing connector” as used herein refers to the portion of the affixing mechanism that secures the removable armature in one end of the hollow spoke or hollow lever. This connector allows for the quick and easy release of the removable armature from the hollow spoke or hollow lever as needed. These types of connectors are well known in the art and include for example, pin and groove connectors, ball and spring connectors and compression washer connectors.

The term “hub” as used herein refers to the element of the safe opening mechanism to which one or more hollow spoke(s) or hollow lever is connected.

The term “pin and groove connector” as used herein refers to any securing connector that utilizes a pin and groove configuration to effect securing of the removable armature in the hollow spoke or hollow lever.

The term “ball and spring connector” as used herein refers to any securing connector that utilizes a ball and spring configuration to effect securing of the removable armature in the hollow spoke or hollow lever.

The term “compression washer connector” as used herein refers to any securing connector that utilizes a compression washer configuration to effect securing of the removable armature in the hollow spoke or hollow lever.

The term “circuit board” as used herein refers to an electronic circuit, however configured, that provides an on/off button or switch to control the amount of electricity from one or more batteries to charge and/or recharge a capacitor and to discharge that stored energy though the protection device spike when penetrating the skin.

The term “released” in reference to the chemical delivered by the spike as used herein refers to dispensing, transferring, dissolving, injecting, or otherwise contacting the chemical with the tissue of an open wound provided in, or on, the protection device spike when penetrating the skin.

The term “safe” as used herein refers to is any device comprising a compartment for storing valuables, a door to seal the storage compartment and a locking mechanism that allows access to those valuables having a security code (e.g., physical, electronic or biometric) that disengages the locking mechanism.

The present invention is a protection device for a safe opening mechanism comprising a removable armature having a first end, a middle and a second end. The first end having a handle grip, the middle having an adapter for connecting to a hollow spoke shaft or hollow lever securing connector of a safe opening mechanism and the second end having an attachment connector and a spike on the second end having a back end and front end, the back end able to be affixed to the attachment connector of the removable armature and the front end being pointed.

### Protection Device

The protection device 10 comprises a removable armature 2 having a handle 4 on the first end, an adapter 6 about the middle, an attachment connector 8 on the second end and a spike 3 having a back end 5 able to be affixed to the attachment connector 8 of the removable armature 2 and the front end 7 being pointed.

### Handle Grip

The handle or handle grip 4 may be provided in a variety of configurations that allow for easy gripping by the user when opening the safe or when defending himself/herself. In one configuration, the handle grip 4 is part of, and inseparable from, the protection device 10. The design appears identical to that of a normal handle grip used on commercially available safes so that a perpetrator would not easily recognize the concealed protection device 10. Alternatively, the handle grip 4 may be interchangeable so that the handle 4 selected may be different from, or identical to, the other handles appearing on the safe. More specifically, the removable armature handle grip 4 may have a threaded adapter for connecting to the removable armature 2. Further, a variety of different surfaces known to those skilled in the art may be provided on the handle grip 4 to allow for better gripping during use. For example, the surface may have a flexible polymer coating that, while smooth in appearance, provides a better gripping surface. Alternatively, the surface may be knurled or have longitudinal or horizontal grooves, depressed dimples, or raised bumps.

In a lever configuration, there is only one handle 4, so the handle's 4 design may not be as obvious in being a protection device. However, handles may be provided that mimic the levers provided on commercially available safes in the event the user prefers a particular configuration or to further conceal the fact that the lever contains a protection device 10.

In a spoked wheel safe handle configuration, one or more of the spokes 20 of the wheel may be hollow and conceal one or more of the protection devices 10 of the present invention. As with the lever configuration, handles 4 may be provided that mimic the other handles of the remaining spokes of the wheel to further conceal the fact that a particular spoke 20 contains a protection device 10. In the event there is only a single hollow spoke 20 containing a protection device 10 it may be indicated in some way so that the owner knows which of the several spokes contains the protection device 10. This indication can be provided in a variety of methods known to those in the art such as a slight textural difference in the handle 4 known to the owner, a specific marking or variation in the regular markings of the handle 4 obvious to the owner or slight configurational difference of the spoke 20 or handle 4 known to the owner but not necessarily observable by the perpetrator.

The handle 4 or lever may be provided in a variety of lengths that mimic those provided on commercially available safes including about 5 cm, about 6 cm, about 7 cm, about 8 cm, about 9 cm, about 10 cm, about 11 cm, about 12 cm. Alternatively, the handle length may range from about 5 to about 7 cm, about 7 to about 9 cm, about 9 to about 11 cm. Further the handle 4 may have a variety of gripping patterns that mimic those provided on commercially available safes or other desirable configurations known to those skilled in the art for providing an adequate grip when using the protection device 10.

The width of the handle 4 or lever may also be provided in a variety of configurations that mimic those provided on commercially available safes including about 1.5 cm, about 2.0 cm, about 2.5 cm, about 3.0 cm, about 3.5 cm, about 4.0 cm, about 4.5 cm, about 5.0 cm. Alternatively the handle width may range from about 1.5 to about 2.5 cm, about 2.5 to about 3.5 cm, about 3.5 to about 5.0 cm.

In other configurations, the handle 4 may be hollow to allow for incorporating a releasing mechanism connected to and for activating the securing connector 24 that secures the protection device 10 within the handle 4 or lever. The releasing mechanism may be any mechanism known to those skilled in the art for securing the protection device 10 in the hollow spoke 20 or hollow lever such that when activated will release the protection device 10 from its hollow housing for immediate use. For example, releasing mechanisms comprising elements contained within the handle 4 of the removable armature 2 may include a push button release configuration that either retracts a pin, releases compression on a flexible polymer washer or activates a spring releasing pressure on ball bearings.

In yet another configuration, the handle grip 4 may further comprise a circuit board 30 and a battery 34 or other energy storage device wherein the circuit board 30 controls the charging, discharging and recharging of a capacitor 32. The capacitor 32 has both positive and negative electrodes 36 exposed on the surface of the protection device 10, such that when the device penetrates the skin the connection between the positive and negative electrodes 10 is completed releasing the electrical charge stored in the capacitor 32. In this configuration, the interior of the handle 4 comprising the circuit board 30 is accessible to allow the user to insert and/or replace the battery 34 and/or energy storage device. Alternatively, the battery 34 and/or energy storage device is rechargeable. In this configuration, the handle 4 may have an adapter that allows a charging cable to be connected to the handle grip 4 for recharging the battery 34 and/or energy storage device for use or reuse.

The handle grip 4 may be made of one or more of a variety of materials including metal, wood, or polymer.

In yet another configuration the handle grip 4 may further comprise a chemical compound that causes extreme irritation and/or pain when the skin is penetrated with the protection device 10. This chemical may be a salt, such as heavy metal salt (e.g., sodium chloride) or other compound such as capsaicin. Any compound may be used that can be made available on or in the protection device 10 of the present invention known to those skilled in the art to cause severe or debilitating pain when introduced through the skin. A variety of methods known to those skilled in the art may be utilized to deliver this chemical under the skin when the protection device 10 is in use. In one configuration, the chemical is dried or coated on the surface of the spike 3 of the protection device 10. In another configuration, crystals of the chemical are released when the protection device 10 penetrates the skin by for example with the use of a moisture dissolvable membrane. In yet another configuration the chemical is provided in a liquid and the handle 4 comprises a reservoir for the chemical, a plunger, and a quick release that is immediately activated, or may be activated by the user, when the protection device 10 enters the skin. Any activation mechanism known to those skilled in the art may be used. A simple configuration comprises a push button that releases a spring that applies pressure to the plunger that when activated injects the chemical under the skin.

### Adapter

The adapter 6 for connecting the protection device 10 to the hollow spoke 20 or lever of a safe opening mechanism may be provided in a variety of configurations and is utilized as a locking mechanism that holds the protection device 10 in place within the hollow spoke 20 or hollow lever when not in use. For example, the adapter 6 may be a pin and groove/channel, ball and spring or compression washer configuration.

In the pin and groove configuration, the locking mechanism may include a pin protruding from the removable armature 2 and a channel formed in a sidewall of the interior of the hollow spoke 20 or lever or vice versa. The pin may be configured to travel within the channel and secure the protection device 10 within the hollow spoke 20 or lever when the pin reaches an end of the channel. A variety of this type of mechanism may be utilized, including for example T-shaped, Y-shaped or L-shaped channel configurations. In each of these configurations, the protection device 10 is inserted and twisted within the hollow spoke 20 or lever to secure the device and is twisted and withdrawn from the hollow spoke 20 or lever to remove the device when needed. In the T-shaped and Y-shaped channels, the protection device 10 may be twisted in either direction to extract or insert it back into or out of the hollow spoke 20 or lever. In the angled L-shaped and the Y-shaped channels, the protection device 10 is twisted and pulled simultaneously to release it from the hollow spoke 20 or lever.

In the ball and spring configuration, one or more ball bearings within the removable armature 2 are pressured into a well within the hollow spoke 20 or lever, or visa versa, by a spring that may be released by pulling or by an activation button on the handle grip 4 of the protective device 10. In one configuration the protection device 10 is inserted into the hollow spoke 20 or lever. During insertion the wall of the hollow spoke 20 or lever presses against the ball bearings causing them to recess prior to reaching the well. When the well is reached the ball bearings are released with a portion of the ball bearing entering the well and locks the protection device 10 in the hollow spoke 20 or lever.

In the compression washer configuration, a flexible polymer washer/ring provided on the removable armature 2 is compressed by a spring that causes the polymer washer/ring to expand along its perimeter edge resulting in pressure against the inside wall of the hollow spoke 20 or lever locking the protection device 10 in place or visa versa. In this configuration, the spring is activated by a push button in the handle grip 4 securing the device in the hollow spoke 20 or lever. When deactivated the spring releases the pressure on the polymer washer/ring retracting the perimeter edge of the washer/ring from the wall of the hollow spoke 20 or lever and releasing the protective device 10 for use.

The above examples are provided to demonstrate some of the methods known to those skilled in the art that may be utilized with the present invention but are not intended to limit the scope of the mechanisms that may be used to secure the protection device in the hollow spoke 20 or lever.

The adapter 6 may be made of a variety of high tensile strength wear resistant materials such as metal or high density polymer.

### Spike

The spike 3 may be any pointed element designed to penetrate the skin. This may be of a pointed cylindrical or pointed flat or geometrical bladed or non-bladed construction. For example, the spike 3 may be made from cylindrical stock material with the end sharpened to a point. The tapering that provides this point may be relegated to a short distance from the end of the cylindrical shaft or may encompass the full length of the cylindrical shaft forming the spike 3.

In the bladed configuration, the spike 3 may be crafted from triangular, square, rectangular or star shaped rod stock material allowing one or more blades to be provided on the spike 3. For example, with the rectangular rod stock material one blade may be provided on one edge or on both edges. In another configuration each apex of the triangular rod stock may be sharpened forming a three bladed spike. In these configurations the tapering may encompass a portion or the entire length of the spike 3.

The spike 3 may be provided in a variety of lengths and will be limited by the length of the hollow spoke 20 or lever within which the protection device 10 is housed. Consequently, the length of the spike 3 includes about 5 cm, about 6 cm, about 7 cm, about 8 cm, about 9 cm, about 10 cm, about 11 cm, about 12 cm, about 13 cm, about 14 cm, and about 15 cm. Alternatively, the spike length may range from about 5 to about 9 cm, about 9 to about 12 cm, about 12 to about 15 cm.

The width of the spike 3 will be limited by the width of the hollow spoke 20 or lever within which the protection device 10 is housed. Consequently, the width may include about 0.7 cm, about 0.8 cm, about 0.9 cm, about 1.0 cm, about 1.1 cm, about 1.2 cm, about 1.3 cm, about 1.4 cm and about 1.5 cm. Alternatively, the handle width may range from about 0.7 to about 1.0 cm, about 1.0 to about 1.3 cm, and about 1.3 to about 1.5 cm.

In other configurations the spike 3 may be hollow to allow for incorporating or housing the positive and negative electrodes 36 of the capacitor 32 exposed on the surface of the spike 3, such that when the protection device 10 penetrates the skin the connection between the positive and negative electrodes 36 is completed. In this configuration the interior of the handle 4 comprises a circuit board 30 and a battery 34 or other energy storage device wherein the circuit board 30 controls the charging and recharging of a capacitor 32 from the battery 34. This charge is released when the electronic circuit 30 is completed.

In another configuration the spike 3 is coated or contains areas where the chemical compounds may be stored prior to release under the skin. In one embodiment compounds are selected that cause extreme irritation and/or pain when the skin is penetrated with the protection device 10. In one configuration the chemical is dried or coated on the surface of the spike 3 of the protection device 10. In another configuration, crystals of the chemical are released when the protection device 10 penetrates the skin by for example the use of a moisture dissolvable membrane.

In yet another configuration the chemical is provided in a liquid and the spike 3 configured like a syringe having a narrow passageway to deliver the chemical from a reservoir provided in the handle grip 4.

The spike 3 may be made of one or more of a variety of materials including metal or high-density polymer.

### Hollow Spoke or Lever

The hollow spoke 20 or lever is designed to provide an adequate area within, to house and keep concealed the spike 3 of the protection device 10 disguised to look like the handle, 4 or one of the handles 4, of the opening mechanism of a commercially available safe. The area provided is larger in length and width of the protection device's spike 3 so that it can be adequately concealed within the hollow spoke 20 or lever.

On end of the hollow spoke 20 or lever is threaded 22 for connecting to the hub of the safe's locking mechanism. The other end is open and comprises a securing connector 24 to engage the adapter 6 of the removable armature 2 for securing the protective device 10 when not in use. The securing connector 24 may be provided on the exterior or the interior of the open end of the hollow spoke 20 or lever. When the securing connector is on the exterior of the open end, the back end of the spike 5 is hollow and the adapter 6 is provided on the inside of the hollow back end 5 of the spike 3. When the securing connector 24 is on the interior of the open end, the adapter 6 is provided on the exterior of the back end 5 of the spike 3.

In some cases, the threaded end 22 of the hollow spoke 20 or lever is not supported by the threaded receiving aperture of the hub. Consequently, a threaded adapter may be provided that affixes to the threaded end of the hollow spoke 20 or lever and is able to be received by the threaded aperture 22 of the hub of a desired safe.

### Safe Handle

The safe opening or locking mechanism includes a handle 4 that is fitted to a hub that connects to gearing elements within the door and transfers motion from the handle 4 to the bolts of the door securing elements that secure the door. The safe handle may be provided in a variety of configurations. In one configuration the handle affixes directly to the hub forming a lever. In another configuration the handle is a wheel constructed on two or more spokes that connect to the hub.

The safe handle 4 may be replaced with the present invention in the form of a hollow lever having a securing connector on one end to affix to the hub and a protection device house within the hollow lever wherein the lever resembles the safe handle provided by the manufacturer of the safe. Alternatively, one or more of the spokes 20 of a wheel handle 4 may be replaced with one or more hollow spokes 20 having a securing connector 24 on one end to affix to the hub and a protection device 10 housed within wherein the spoked wheel resembles the safe handle provided by the manufacturer of the safe.

### Discussion of Drawings and Use

Implementations of the safe handle relate to handles for safes, such as firearm safes. Particular implementations also include safe handles having a removable blade.

The safe handle may be configured to attach to a firearm safe or any other type of safe. In various implementations, the safe handle may be configured to rotatably couple to the safe.

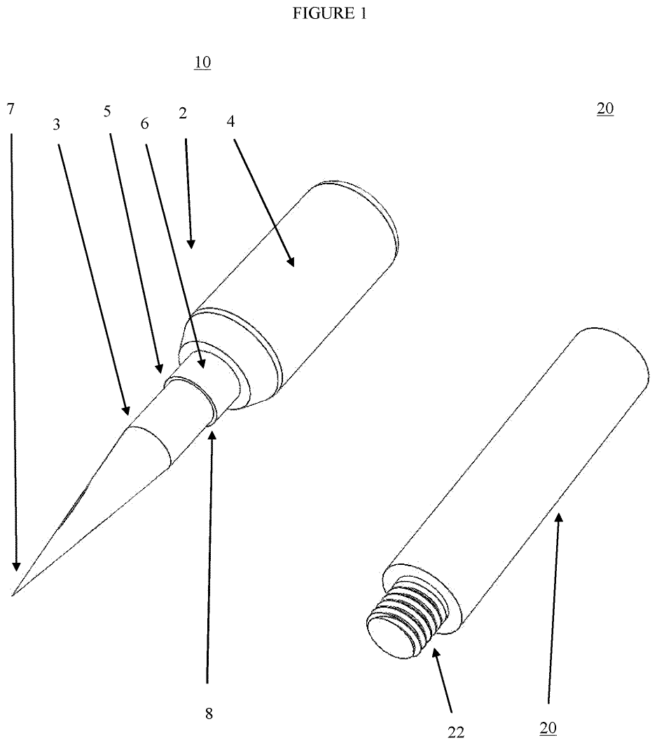

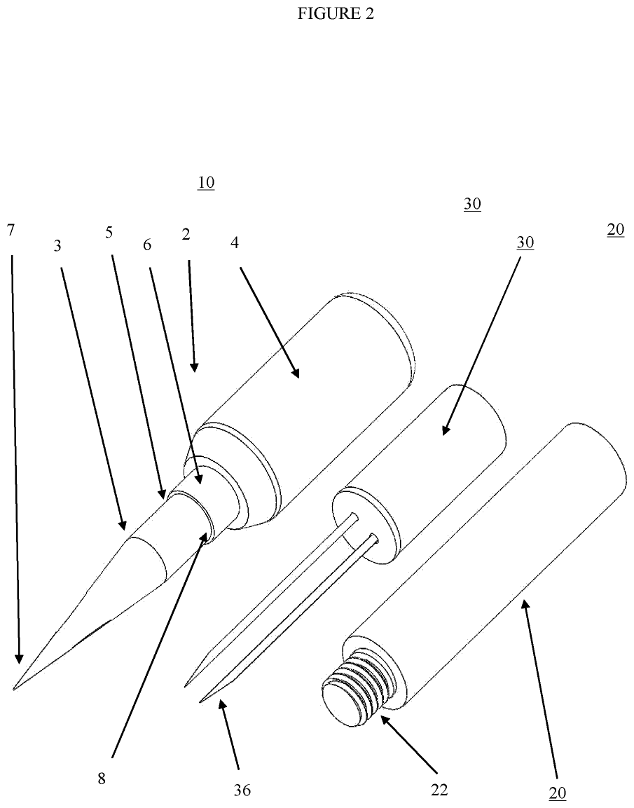

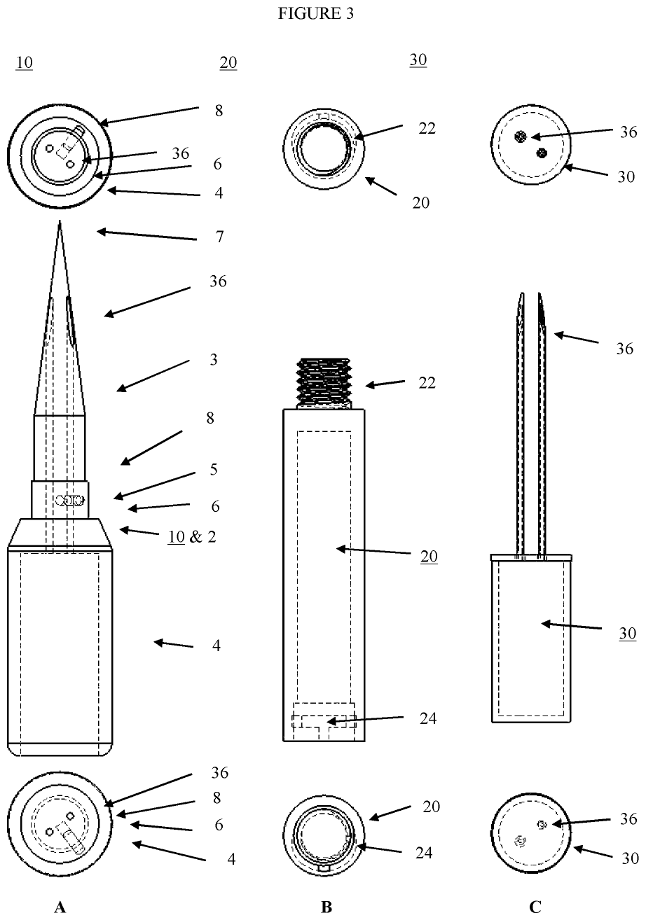

The safe handle includes a hub and one or more shafts directly coupled to the hub. In various implementations, the safe handle includes a single shaft, two shafts, three shafts, four shafts, five shafts, six shafts, or more than six shafts. In various implementations, the one or more shafts are fixedly and non-removably attached to the hub. In other implementations any or all of the one or more shafts are removably attached to the hub. Referring to FIGS. 1 and 2, a side perspective view of a shaft is illustrated. Referring to FIG. 3A, a side view of the shaft, a front view of the shaft of FIGS. 1 and 2 are illustrated. In implementations where any or all of the one or more shafts are removably coupled to the hub, an end of the one or more shaft includes a threaded portion. The threaded portion may be configured to thread within a threaded opening within the hub. In other implementations, any or all of the one or more shafts may be configured to removably couple to the hub through other coupling mechanisms.

Any or all of the one or more shafts may be configured to receive a knife. In such implementations, a volume within the shaft may either correspond to the shape of a knife blade or may be larger than the knife blade in order to receive an entirety of the knife blade. While much of this document describes a shaft configured to receive a knife, it is understood that the safe handle may include multiple shafts, each or any of the multiple shafts configured to receive a knife. In particular implementations, every shaft of the one or more shafts may be configured to receive a knife. In other implementations, only one of the shafts, two of the shafts, three of the shafts, or more than three of the shafts may each be configured to receive a knife. Likewise, in such implementations, the safe handle may include as many knives as there are shafts configured to receive knives. In implementations where the safe handle includes more shafts than it does knives, either the one or more knives or the shafts configured to receive the one or more knives may be visually distinguishable from the non-knife containing shafts in order to allow a user to know which shaft includes a knife. In other implementations where the safe handle includes more shafts than it does knives, either the one or more knives or the shafts configured to receive the one or more knives may be physically distinguishable (through, for example, a slightly raised bump or groove on the portion of the knife or shaft facing the safe) from the non-knife containing shafts in order to allow a user to know which shaft includes a knife. In implementations where the safe handle includes more shafts than knives, the non-knife containing shafts may include a handle fixed to the end of the shaft similar to the handles of the knives. In such implementations, the knives may be concealed within the safe handle.

The knives disclosed herein all include a blade and a handle. Referring to FIG. 3C, a first implementation of a knife is illustrated. In various implementations, the blade of the knife (and any other knife of the safe handle) may be conical. In such implementations, the knife may be primarily configured to stab with the point of the blade rather than cut with an edge of the blade.

Referring to FIGS. 1 and 2, a perspective side view of a second implementation of a knife is illustrated. Referring to FIG. 3C, a side view of the knife of FIGS. 1 and 2 is illustrated. Referring to FIG. 3C, a front view of the knife of FIGS. 1 and 2 is illustrated. In various implementations, the blade of the knife may include a single cutting edge, two cutting edges, or three cutting edges.

In various implementations, the length of the blade of any knife disclosed herein may be 2.5 inches long. In other implementations, the length of the blade may be more than or less than 2.5 inches long. In particular implementations, the length of the blade may be 4 inches. The length of the blade may be configured to fit entirely within a corresponding shaft.

In various implementations, the handle of any of the knives disclosed herein may also serve as a handle of the shaft of the safe handle. In turn, the handle may be used to both handle the knife when the knife is withdrawn from the shaft and to also handle the safe handle when opening the safe. In other implementations, the handles of any of the knives disclosed herein may include other shapes, dimensions, or designs. In particular implementations, and as illustrated by FIGS. 1, 2 and 3C, the handle may include a tapered portion sloping towards the blade. In other implementations, the handle may not include this tapered portion.

The knife is configured to secure within the shaft in a manner that prevents the knife from falling from the shaft when the safe handle is at rest or when the safe handle is being used to open the safe. In various implementations, the safe handle includes a locking mechanism that secures the knife within the shaft. In particular implementations, the locking mechanism may include a pin protruding from the knife and a channel formed in a sidewall of the interior of the shaft. The pin may be configured to travel within the channel and secure the knife within the shaft when the pin reaches an end of the channel. In each of these implementations, the knife is inserted and twisted within the shaft to secure the knife within the shaft and is twisted and withdrawn from the shaft to yield the knife. In the implementation with the T-shaped and Y-shaped channels, the knife may be twisted either direction to insert the knife. In the implementations of the angled L-shaped channel and the Y-shaped channel, the knife is twisted and pulled simultaneously to release the knife from the shaft.

In various implementations, the terminal ends of any of the channels may be tapered. In such implementations, the pin may form a friction fit against the tapered end and secure the knife within the shaft.

In other implementations the pin may protrude from a sidewall of the interior of the shaft and the knife may include any of the channels disclosed herein.

In other implementations, other locking mechanisms may be used to secure the knife within the shaft. These mechanisms may include, by non-limiting example, a threaded portion (that may include a multi-start thread) that threads the knife into the shaft, magnetic mechanisms, or a pressure fit mechanism between the knife and the sidewall of the interior of the shaft (rather than the channel within the interior of the shaft).

The locking mechanisms disclosed herein may sufficiently lock the knife within the shaft to a degree that prevents a child from withdrawing the knife from the shaft.

While this document primarily discusses a safe handle, in various implementations the knives and shafts disclosed herein may be included in a kit without a hub. These kits may be used to retrofit existing safe handles by removing the existing shafts of a safe handle and then inserting the new shafts (that may contain knives) into the hub. The kits may include any number of shafts, including knife receiving shafts or non-knife receiving shafts, and knives that are disclosed herein.

Implementations of the safe handle disclosed herein may provide security to a user who is being forced against their will (by, for example, a perpetrator) to open a safe. In such implementations, as the user begins to open the safe, their hand grasps the handle of the knife without the perpetrator knowing. The user then may withdraw the knife and defend themselves with a weapon against the perpetrator.

The safe handles described herein may be made of conventional materials used to make goods similar to these in the art, such as, by non-limiting example, metal, ceramics, plastics, or composites. Those of ordinary skill in the art will readily be able to select appropriate materials and manufacture these products from the disclosures provided herein.

The implementations listed here, and many others, will become readily apparent from this disclosure. From this, those of ordinary skill in the art will readily understand the versatility with which this disclosure may be applied.

It will be appreciated that, for clarity purposes, the above description has described embodiments of the invention with reference to different functional units and processors. However, it will be apparent that any suitable distribution of functionality between different functional units, processors or domains may be used without detracting from the invention. For example, functionality illustrated to be performed by separate units, processors or controllers may be performed by the same unit, processor or controller. Hence, references to specific functional units are only to be seen as references to suitable means for providing the described functionality, rather than indicative of a strict logical or physical structure or organization.

What is claimed is:

1. A protection device for a safe opening mechanism comprising:
a removable armature having a first end, a middle and a second end, said first end having a handle grip, said middle having an adapter for connecting to a spoke shaft or lever securing connector of a safe opening mechanism and said second end having an attachment connector; and
a spike having a back end and front end, said back end able to be affixed to said attachment connector of said armature and said front end being pointed.

2. A handle for a safe opening mechanism comprising:
a hollow spoke shaft or lever having two ends, one end having a threaded portion for affixing said hollow spoke shaft or lever to a safe opening mechanism and the other end having a securing connector;
a removable armature having a first end, a middle and a second end, said first end having a handle grip, said middle having an adapter for connecting to a spoke shaft or lever securing connector of a safe opening mechanism and said second end having a attachment connector; and
a spike having a back end and front end, said back end able to be affixed to said attachment connector of said armature and said front end being pointed.

3. A safe having an opening mechanism handle comprising:
a secure compartment for storing items having a door;
an opening mechanism in said door to secure said items stored in said secure compartment;
a hollow spoke shaft or lever having a first end and a second end, said first end having a threaded portion for affixing said hollow spoke shaft or lever to said safe opening mechanism said second end having a securing connector;
a removable armature having a first end, a middle and a second end, said first end having a handle grip, said middle having an adapter for connecting to said hollow spoke shaft or lever securing connector of said safe opening mechanism and said second end having an attachment connector; and
a spike having a back end and front end, said back end able to be affixed to said attachment connector of said removable armature and said front end being pointed.

4. The handle for a safe according to claim 2, wherein said handle comprises a hub with two or more hollow spokes wherein said at least one of said hollow spokes contains a protection device comprising:
a removable armature having a handle grip on one end, an adapter about its middle for connecting to a spoke shaft or lever securing connector of a safe opening mechanism and an attachment connector on the other end; and
a spike having a back end and front end, said back end able to be affixed to said attachment connector of said removable armature and said front end being pointed.

5. The safe handle according to claim 2, wherein the securing connector of said hollow spoke shaft is a pin and groove connector, a ball and spring connector or a compression washer connector.

6. The safe handle of claim 5, wherein said hollow spoke shaft comprising an L-shaped channel and said removable armature comprising a pin configured to fit within the L-shaped channel, wherein the pin locks within the L-shaped channel through a pressure fit.

7. The safe handle of claim 6, wherein the L-shaped channel forms an angle greater than 90 degrees.

8. The safe handle of claim 5, wherein said hollow spoke shaft comprising a T-shaped channel and said removable armature comprising a pin configured to fit within the T-shaped channel, wherein the pin locks within the T-shaped channel through a pressure fit.

9. The safe handle of claim 5, wherein said hollow spoke shaft comprising a Y-shaped channel and said removable armature comprising a pin configured to fit within the Y-shaped channel, wherein the pin locks within the Y-shaped channel through a pressure fit.

10. The protection device according to claim 1, wherein said handle is hollow and comprises a battery connected to a electronic circuit, wherein said electronic circuit controls and is connected to a capacitor wherein in said capacitor is charged by said battery and has a positive and a negative electrode exposed on the surface of said spike such that when there is connectivity of the negative and positive electrodes a charge in said capacitor is discharged.

11. The protection device according to claim 1, wherein said spike comprises a chemical that causes severe pain or incapacitates an individual when the skin of said individual is penetrated by said spike, wherein said chemical is a heavy metal salt and is coated on the surface of said spike or is released from said spike upon impact with said individual.

12. The handle according to claim 2, further comprising a threaded adapter, wherein said threaded adapter may be affixed to said securing connector of said hollow spoke shaft or lever to allow attachment of said hollow spoke shaft or lever to different types of safe opening mechanisms.

13. A safe handle comprising:
a hub configured to couple to a safe;
a first shaft directly coupled to the hub;
a second shaft directly coupled to the hub;
a third shaft directly coupled to the hub;
a first knife comprising a blade and a handle, the first knife removably coupled within the first shaft;
a second knife comprising a blade and a handle, the second knife removably coupled within the second shaft; and
a third knife comprising a blade and a handle, the third knife removably coupled within the third shaft.
